(19) United States
(12) Patent Application Publication
(10) Pub. No.: US 2021/0125069 A1
(43) Pub. Date: Apr. 29, 2021

(54) SECURE AND PRIVATE NEURAL COMPUTATION WITH ERROR CORRECTING CODES

(71) Applicants: Netanel Raviv, St. Louis, MO (US); Jehoshua Bruck, Pasadena, CA (US); Siddharth Jain, Pasadena, CA (US); Anxiao Jiang, College Station, TX (US); Pulakesh Upadhyaya, College Station, TX (US)

(72) Inventors: Netanel Raviv, St. Louis, MO (US); Jehoshua Bruck, Pasadena, CA (US); Siddharth Jain, Pasadena, CA (US); Anxiao Jiang, College Station, TX (US); Pulakesh Upadhyaya, College Station, TX (US)

(73) Assignees: Washington University, St. Louis, MO (US); Texas A&M University, College Station, TX (US); California Institute of Technology, Pasadena, CA (US)

(21) Appl. No.: 17/084,627

(22) Filed: Oct. 29, 2020

Related U.S. Application Data
(60) Provisional application No. 62/927,249, filed on Oct. 29, 2019.

(51) Int. Cl. G06N 3/08; G06F 11/10

(52) U.S. Cl. CPC G06N 3/08; G06F 11/10

(57) ABSTRACT

Computer-aided methods for performing computations using adversarially-robust neural networks is disclosed that includes providing a uncoded neural network comprising a plurality of neurons and associated inputs for each of the plurality of neurons, each neuron configured to perform a calculation according to an activation function. The method further includes transforming, using the computing device, at least one uncoded neuron into a coded neuron by adding, using the computing device, an error correcting code as an additional input to the at least one uncoded neuron, the error correcting code comprising a redundant combination of the associated inputs off the uncoded neuron, and revising, using the computing device, the activation function of the at least one uncoded neuron to accommodate the error correcting code as the additional input.

### CROSS-REFERENCE TO RELATED APPLICATIONS

This application claims priority from U.S. Provisional Application Ser. No. 62/927,249 filed on Oct. 29, 2019, which is incorporated herein by reference in its entirety.

### STATEMENT REGARDING FEDERALLY SPONSORED RESEARCH OR DEVELOPMENT

This invention was made with government support under 131769 awarded by the National Science Foundation. The government has certain rights in the invention.

### FIELD OF THE DISCLOSURE

The present disclosure generally relates to computation with neural networks.

### BACKGROUND OF THE DISCLOSURE

Deep Neural Networks (DNNs) have become a dominating force in Artificial Intelligence (AI), bringing revolutions in science and technology. A massive amount of academic and industrial research is devoted to implementing DNNs in hardware. Hardware-implemented DNNs are appearing in phones, sensors, healthcare devices, and more, which will revolutionize every sector of society, and make AI systems increasingly energy-efficient and ubiquitous. Nevertheless, the crux of this phenomenal success lies in heuristics rather than deep theoretical understanding; and consequently, neural decision making is exposed to a plethora of safety concerns.

However, DNNs are known to be highly susceptible to adversarial interventions. Computation with neural networks (also known as neural computation) is highly sensitive to noise, be it adversarial or random. This sensitivity impedes the ability of current technology to guarantee secure neural computation, and makes such computation hard to implement in hardware. Recently it was demonstrated that adding a small (and often indistinguishable to humans) amount of noise to the inputs of a DNN may cause the DNN to reach nonsensical conclusions. More recently, some DNN architectures may experience similar effects by changing as little as one or two entries of the input. These observations reveal an orthogonal concern of a similar nature from the adversarial machine learning perspective: performance degradation due to malicious attacks.

There exists a rich body of research that studies how to make DNNs robust to noise, including noise injected into the neurons/synapses of DNNs or into DNN inputs. However, solutions to date have been almost exclusively heuristic.

To combat adversarial attacks to the inputs, much focus was given on adjusting the training process to produce more robust DNNs, e.g., by adjusting the regularization expression, or the loss function. Existing techniques to combat noise in neural networks rely on re-training with adversarial examples, or replicating the network. Re-training techniques are inherently heuristic, and therefore cannot provably guarantee resilience against noise. Further, re-training methods often result in intractable optimization problems, and succeed insofar as solving them is possible. Replication can be proven to work, but guarantees very low resilience at high overhead.

Combating noise in neurons/synapses has also enjoyed a recent surge of interest. Most of this line of research focuses on replication methods (called augmentation), retraining, and providing statistical frameworks for testing fault tolerance of DNNs (e.g., training a DNN to remember a coded version of all possible outputs). To a certain degree, DNNs tend to present some natural fault-tolerance without any intervention. This phenomenon is conjectured to be connected to over-provisioning, i.e., the fact that in most cases one uses more neurons than necessary, but rigorous guarantees remain elusive.

Adding redundancy to datasets has proven incredibly advantageous in combating similar concerns in communications. These gains were mostly thanks to the development of error correcting codes (ECCs), a well-established family of mathematical objects. In recent years ECCs have found applications in computations to guarantee security and privacy at very low computational overhead in many tasks of interest in machine learning.

However, the gist of ECCs, and their recent success in distributed computation applications, lies in their algebraic nature. ECCs are typically defined in terms of linear transformations and polynomials, and hence are tailor-made for tasks of similar nature such as matrix-matrix multiplication and gradient computations. Therefore, ECC-aided computation techniques fall short in accommodating the inherent non-linearity of NNs.

### SUMMARY

In one aspect, computer-aided method for performing computations using adversarially-robust neural networks is disclosed that includes providing a uncoded neural network comprising a plurality of neurons and associated inputs for each of the plurality of neurons, each neuron configured to perform a calculation according to an activation function. The method further includes transforming, using the computing device, at least one uncoded neuron into a coded neuron by adding, using the computing device, an error correcting code as an additional input to the at least one uncoded neuron, the error correcting code comprising a redundant combination of the associated inputs off the uncoded neuron, and revising, using the computing device, the activation function of the at least one uncoded neuron to accommodate the error correcting code as the additional input.

Other objects and features will be in part apparent and in part pointed out hereinafter.

### DESCRIPTION OF THE DRAWINGS

Those of skill in the art will understand that the drawings, described below, are for illustrative purposes only. The drawings are not intended to limit the scope of the present teachings in any way.

FIG. 1 is a block diagram schematically illustrating a system in accordance with one aspect of the disclosure.

FIG. 2 is a block diagram schematically illustrating a computing device in accordance with one aspect of the disclosure.

FIG. 3 is a block diagram schematically illustrating a remote or user computing device in accordance with one aspect of the disclosure.

FIG. 4 is a block diagram schematically illustrating a server system in accordance with one aspect of the disclosure.

FIG. 5A is an image illustrating an example of a dataset that includes a set of binary entries defining an image of a stop sign.

FIG. 5B is an image illustrating the dataset of FIG. 5A with a malicious intervention in the form of a sticker on the stop sign.

FIG. 5C is an image illustrating the dataset of FIG. 5A with an added redundancy that does not interfere with human perception.

FIG. 5D is an image illustrating the dataset with the added redundancy of FIG. 5C that further includes the malicious intervention of FIG. 5B.

FIG. 6A is a schematic diagram of an uncoded neuron.

FIG. 6B is a schematic diagram of a coded neuron in accordance with an aspect of the disclosure.

FIG. 7A is a schematic diagram of an uncoded neuron.

FIG. 7B is a schematic diagram of a coded neuron with one added bit of redundancy configured to compute τ(x) even if a synapse is erased.

FIG. 7C is a schematic diagram of a coded neuron with one added bit of redundancy inside a deep neural network (DNN), in which the coded neuron τ₄ computes τ₄(y) even if any of its incoming synapses is erased, where y is the output of the neurons τ₁, τ₂, and τ₃ in the previous layer.

There are shown in the drawings arrangements that are presently discussed, it being understood, however, that the present embodiments are not limited to the precise arrangements and are instrumentalities shown. While multiple embodiments are disclosed, still other embodiments of the present disclosure will become apparent to those skilled in the art from the following detailed description, which shows and describes illustrative aspects of the disclosure. As will be realized, the invention is capable of modifications in various aspects, all without departing from the spirit and scope of the present disclosure. Accordingly, the drawings and detailed description are to be regarded as illustrative in nature and not restrictive.

### DETAILED DESCRIPTION OF THE INVENTION

In various aspects, systems and methods for handling noise in deep neural networks (DNNs) are disclosed. In some aspects, the disclosed methods include encoding the inputs to neurons using an error correcting code and modifying the neurons to accommodate the encoded input so that correct output of the computation is guaranteed as long as the noise level is below a certain threshold. In other aspects, the encoding function of the error correcting code is simpler than conducting the computation itself, and applies universally to a large family of neurons. In other additional aspects, the disclosed systems and methods make use of efficient end-to-end design that does not require decoding. Various examples of the disclosed method are described in Raviv et al. 2020, “CodNN—Robust Neural Networks From Coded Classification”, 2020 IEEE International Symposium on Information Theory (ISIT), pp. 2688-2693, the content of which is incorporated by reference herein in its entirety.

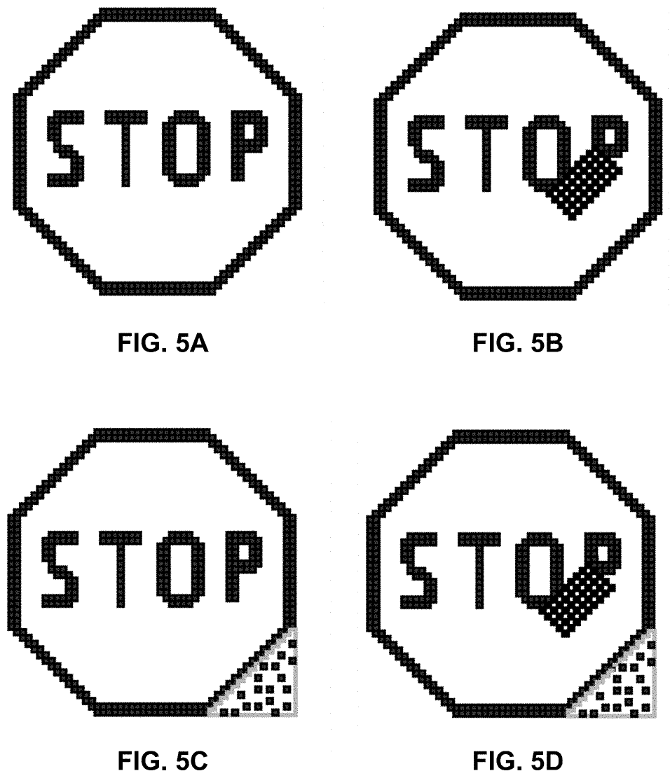

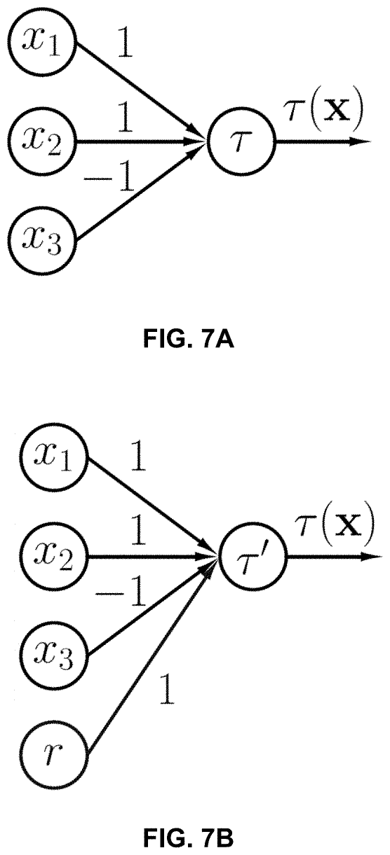

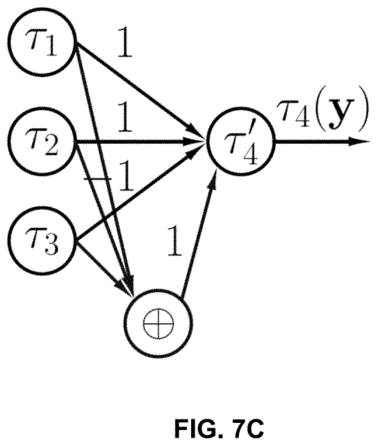

By way of non-limiting example, one aspect of the disclosed method is depicted in FIGS. 5A, 5B, 5C, and 5D in the context of DNN-assisted stop-sign classification. In this non-limiting example, an autonomous vehicle uses a DNN to classify a stop sign (FIG. 5A) within an image. The passenger may be exposed the to the perils of misclassification due to noise within the image, such as a sticker adhered to the stop sign as illustrated in FIG. 5B. In this example, the addition of redundancy to the actual physical object as illustrated in FIG. 5C aids the DNN in classification under noise; as illustrated in FIG. 5D. To facilitate this DNN-assisted vision, the neurons inside the DNN are revised to accommodate the added redundancy by modifying uncoded neurons (see FIG. 7A) to add weighted synapses (see FIG. 7B). Alternatively, the inputs to some neurons within the DNN may come from other neurons inside the network, rather than from the physical world. This alternative modification better encapsulates hardware failures, and redundancy is computed by additional components inside the DNN as illustrated in FIG. 7C.

In some aspects, the input to the neural network is coded with error correcting codes. Error correcting codes are mathematical objects previously used in communication and algebraic computations, but not studied in the context of computation with neural networks. The incorporation of error correction codes into the inputs of neural networks assures that resulting computations of the neural networks are correct, even if some bits or neurons are corrupted by an adversary or by random noise. Unlike existing methods, the assurance of correct calculations are provably true in all cases, rather than being true only probabilistically.

Guaranteeing private computation, i.e., that no information about the input can be inferred by a person holding the network, is currently a work in progress. In various aspects, the disclosed methods assure adversarially-robust neural computation by adding redundancy with error correcting codes to inputs of the neural networks. The disclosed methods make use of both theoretical and practical methods to apply known mathematical notions in a fundamentally new way.

### A. Redundancy and Error Correcting Codes

In various aspects, the incorporation of error correcting codes (a process known as coding) includes adding redundant entries to a dataset. By way of non-limiting example, one can add the redundant entry x1+x2 to a dataset which consists of two numbers x1 and x2. Then, the redundant dataset (x1, x2, x1+x2) is resilient against adversarial corruption of any single entry; the values of x1 and x2 can be readily extracted from the remaining two entries in all cases. ECCs can also guarantee perfect privacy—in a classic result known as the Shamir secret sharing scheme, one can add a randomly chosen entry to the dataset, encode by using only linear operations, and guarantee that a computationally unbounded adversary, which views only a part of the coded dataset, cannot obtain any information whatsoever.

### B. Coding for Computation

Coding has seen tremendous success in communication and storage, but until very recently it was not clear how computations can be made on coded data. While any computation can be carried out on the dataset itself, it was generally believed that computing over redundant entries is futile. Recent breakthroughs in the past few years have demonstrated that this is far from being true. By way of non-limiting example, in the most common task of matrix multiplication, one can partition the given matrices to their constituent submatrices, apply an error correcting code, and distribute the coded data across workers in a distributed computation system. This way, the computation can be carried out even in the presence of stragglers (servers that crash or are slow to respond) and adversaries (servers that reply with a purposely erroneous result), and Shamir-flavored techniques guarantee privacy. By way of another non-limiting example, similar gains can be attained in a distributed execution of gradient descent, by computing the gradient multiple times on a redundant dataset and coding the results.

However, application of error correcting codes to neural networks are accompanied by high degree representations, potentially hampering efficient coding. While matrix multiplication is represented as a polynomial of degree two, and in many cases gradients are represented as low-degree polynomials, activation functions are normally not represented as polynomials. Attempts to represent or approximate activation functions such as sign, ReLU, or sigmoid by polynomials, end up with poor results or high degree, a detriment to efficient coding. In various aspects, the disclosed method make use of a geometric approach, which disregards the algebraic properties needed for traditional coding.

### C. Coded Neurons

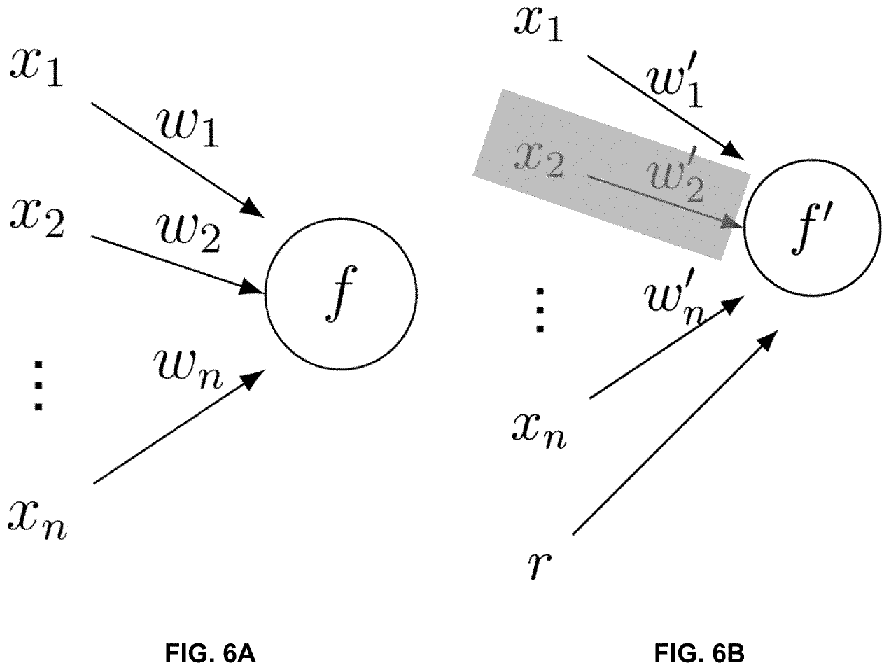

By way of non-limiting example, the disclosed method of coded neural computation was applied to a binarized neural network. Binarized neural networks may be characterized as a function of the form ƒ(x)=sign(w·x^{T}), where x is a ±1 valued input vector, and w is a ±1 vector containing weights that are obtained through training. In this example, an uncoded neuron ƒ (see FIG. 6A) was modified using a simple error correcting code. In particular, a coded neuron ƒ′ (FIG. 6B) was constructed by adding an additional input r to the uncoded neuron ƒ (FIG. 6A). In the coded neuron, ƒ′(x, r) computes ƒ correctly, even if any input bit is erased by an adversary, as represented by the superimposed box over input x₂ in FIG. 6B.

In various aspects, the addition of the simple error correcting code as described above rendered the neuron capable of noise-resilient computation off. This result holds provably true in all cases, without resorting to probabilistic guarantees or re-training. In this example, the extra redundancy bit r of the coded neuron (see FIG. 6B) is given by a parity code, and can be computed with other neurons employing any known method without limitation including, but not limited to the method described in a classic and almost-forgotten technique by Muroga 1959, “The Principle of Majority Decision Logical Elements and the Complexity of their Circuits,” IFIP Congress, the content of which is incorporated by reference in its entirety.

In various aspects, the disclosed methods render a neural network capable of noise-resilient computation by the addition of simple error correcting code to enlarge the NN, either by computing extra bits in the input (see FIG. 7B) or by adding neurons (see FIG. 7C), thereby guaranteeing resilient and private computation in the presence of malicious entities.

### D. Characterization of Deep Neural Networks

As described herein, a deep neural network (DNN) refers to a layered and directed acyclic graph, in which the first layer is called the input layer. Each edge (or synapse) corresponds to a real number called a weight, and nodes in intermediate layers (also referred to herein as hidden layers) are called neurons. Each neuron acts as computation unit that applies some activation function on its inputs, weighted by the respective synapses. The results of the computations in the last layer are the outputs of the DNN.

In some aspects, the activation function of each neuron is sign(xw^{T}−θ), where x is a vector of inputs, w is a vector of weights, θ is a constant called bias, and

$$sign ( x ) = \{ \begin{matrix}1 & if x \geq 0 \\ - 1 & if x < 0\end{matrix}$$

In other aspects, DNNs employ continuous approximations of sign(⋅), including, but not limited to, sigmoid functions to enable analytic learning algorithms including, but not limited to, backpropagation. Non-limiting examples of suitable sigmoid functions include

$$logistic ( x ) = \frac{1}{1 + exp ( - x )} ,$$

tan h(x), and piecewise linear alternatives such as ReLU(x)=max{0, x}. In various aspects, the inputs may include any suitable input known in the art without limitation. In some aspects, the inputs are binary ±1 inputs, which correspond to the binary field [symbol] ₂ by identifying 0 as 1 and 1 as −1, and exclusive or as product.

At the computational level, faults in DNN hardware may include any known DNN hardware faults without limitation. Non-limiting examples of DNN hardware faults include bit-errors, bit-erasures or analog noise, which can be permanent or transient. In some aspects, the DNN hardware faults include bit-errors and bit-erasures, that are formally defined shortly. As described herein, scalars may be represented by lowercase letters a, b, . . . , vectors may be represented by lowercase boldface letters a, b, . . . , and the same letter may be used to refer to a vector and its entries (e.g., a=(a₁, a₂, . . . )). As used hererin, di(⋅, ⋅), ∥⋅∥ᵢ, and [symbol] ᵢ(z, r) denote the distance, lᵢ-norm, and lᵢ-ball cantered at z with radius r, respectively, for i∈{0, 1, 2, . . . , ∞}. As used herein, d_{H} (⋅, ⋅) denotes Hamming distance, and 1ₘ represents be a vector of m ones.

In accordance with the disclosed method in one aspect, for a given neuron τ: [symbol] ₂ⁿ→ [symbol] ₂, where τ(x)=sign(x·w^{T}−θ) for some w∈ [symbol] ⁿ and θ∈ [symbol] a triple (E, v, μ) is called a solution, where E: [symbol] ₂ⁿ→ [symbol] ₂^{m}, v∈ [symbol] ^{m}, and μ∈ [symbol] . The respective coded neuron is τ′(E(x))=sign(E(x)v^{T}−μ). For nonnegative integers t and s, the coded neuron τ′ is robust against t erasures and s errors ((t, s)-robust, for short) if for every disjoint t-subset [symbol] ⊆[m], and s-subset [symbol] ⊆[m], we have that

sign(x·w^{T}−θ)=

sign( [symbol] E(x)ⱼvⱼ− [symbol] E(x)ⱼvⱼ−μ) Eqn. (1)

for every x∈ [symbol] ₂ⁿ.

In this aspect, when computing over data encoded by E, correct output for every x∈ [symbol] ₂ⁿ is guaranteed, even if at most t of the inputs to τ′ are omitted (erasures), and at most s are negated (errors). Further, for a nonnegative integer r we say that τ′ is r—robust if it is (t, s)-robust for every nonnegative t and s such that t+2 s≤r.

For v∈ [symbol] ^{m} and μ∈ [symbol] , let [symbol] (v, μ)={y∈ [symbol] ^{m}|yv^{T}=μ}. For a given solution (E, v, μ), the minimum distance of the respective coded neuron is given by

$$d = d ( E , v , μ ) = {d}_{1} ( E ( {𝔽}_{2}^{n} ) , ℋ ( v , μ ) ) = {min}_{x ∈ {𝔽}_{2}^{n}} {d}_{1} ( E ( x ) , ℋ ( v , μ ) ) .$$

The choice of the [symbol] ₁-metric is discussed in additional detail below. In various aspects, a relative distance d/m is a figure of merit by which a given solution is evaluated.

By way of non-limiting example, for a given neuron τ, and an integer m, an error correcting code may be given by

$$E ( x ) = \{ \begin{matrix}{1}_{m} & if τ ( x ) = 1 \\ - {1}_{m} & if τ ( x ) = - 1\end{matrix}$$

In this example, the solution (E, 1ₘ, 0) is (m−1)-robust.

In various aspects, for layers in DNNs containing multiple neurons, robust DNNs may be constructed using joint coding E for a large family of neurons.

By way of another non-limiting example, for a given set of neurons {τᵢ(x)=sign(xwᵢ^{T}− [symbol] a joint coding function E and {vᵢ, [symbol] that maximizes

$$\frac{{d}_{m i n}}{m}$$

may be found as described below, where

$${d}_{m i n} = {min}_{i ∈ [ ℓ ]} d ( E , {v}_{i} , {μ}_{i} ) .$$

In this non-limiting example, the functions E encode binary linear codes, due to their prevalence in hardware and ease of analysis. Since the {±1}-representation of [symbol] ₂ is used below, every entry of E(x) is a multilinear monomial in the entries of x. FIG. 7A depicts the uncoded neuron τ(x)=sign(x₁+x₂−x₃), and FIG. 7B depicts its coded version τ′(x)=sign(x₁+x₂−x₃+r), where r=x₁x₂x₃.

Table I shows two examples of robustness of the encoded neuron to any 1-erasure.

TABLE I
Computation of τ(•) using the encoded neuron (FIG. 7B)

| (x₁, x₂, x₃, r) | Erasure | τ′(noisy E(x)) = τ (x) |
|---|---|---|
| (1, −1, 1, −1) | x₁ | sign(0 − 1 − 1 − 1) = −1 |
| | x₂ | sign(1 − 0 − 1 − 1) = −1 |
| | x₃ | sign(1 − 1 − 0 − 1) = −1 |
| | r | sign(1 − 1 − 1 − 0) = −1 |
| (−1, 1, −1, 1) | x₁ | sign(−0 + 1 + 1 + 1) = 1 |
| | x₂ | sign(−1 + 0 + 1 + 1) = 1 |
| | x₃ | sign(−1 + 1 + 0 + 1) = 1 |
| | r | sign(−1 + 1 + 1 + 0) = 1 |

E. Robustness and the [symbol] ₁-Metric

In various aspect, an [symbol] ₁-metric may be used to obtain robustness as described below. First, notice that errors and erasures while evaluating τ′ can be seen as changes in E(x). For example, let v=(v₁, v₂, v₃) and E(x)=(y₁, y₂, y₃), and then an erasure at entry 1 is equivalent to evaluating τ′ at the point (0, y₂, y₃). Similarly, an error in entry 2 is equivalent to evaluating τ′ at (y₁, −y₂, y₃).

As such, both errors and erasure can be seen as evaluation of the same coded neuron on a data point which is shifted along axis-parallel lines. Therefore, the encoded points must be far away from [symbol] (v, μ) in [symbol] ₁-distance. More precisely, since error and erasures do not cause any point to shift outside the closed hypercube [−1, 1]^{m}, it is only necessary to have large [symbol] ₁-distance from [symbol] ′= [symbol] ′^{(v,μ)}= [symbol] (v,μ)∩[−1,1]^{m}.

In various aspect, a formula for the [symbol] ₁-distance of a point from a hyperplane is provided below. For every z∈ [symbol] ^{m},

$${d}_{1} ( z , ℋ ) = \frac{\vert z \cdot {v}^{T} - μ \vert}{{‖ v ‖}_{∞}} .$$

A necessary and sufficient condition for the robustness of a coded neuron is provided by τ′(E(x))=sign(E(x)v^{T}−μ). Positive points of T are denoted by [symbol] ⁺ and negative points by [symbol] ⁻.

For a positive integer r and a neuron τ(x)=sign(xw^{T}−θ), a coded neuron τ′(x)=sign(E(x)v^{T}−μ) is r-robust if and only if

sign(xw^{T}−θ)=sign(E(x)v^{T}−μ) Eqn. (2)

for every x∈ [symbol] ₂ⁿ, r≤d₁(E( [symbol] ⁺, [symbol] ′), and r<d₁(E( [symbol] ⁻, [symbol] ′).

By way of proof of the above relation, assume that the conditions in Eqn. (2) hold. To show that τ′ is r-robust Eqn. (1) is demonstrated to hold for every x∈ [symbol] ₂ⁿ and for every mutually disjoint [symbol] and [symbol] such that | [symbol] |+2| [symbol] |≤r. Assuming for contradiction that τ′ is not r-robust, there exists some x∈ [symbol] ₂ⁿ and corresponding sets [symbol] and [symbol] such that E(x) is misclassified under erasures in [symbol] and errors in [symbol] . Since any set of errors or erasures keeps E(x) inside [−1, 1]^{m}, it follows that this misclassification of E(x) corresponds to moving it along an axis-parallel path P of length |P|=| [symbol] |+2| [symbol] |, which crosses [symbol] ′.

If x∈ [symbol] ₂ⁿ, then to attain misclassification |P|>d₁(E(x), [symbol] ′). However, this implies that r≥| [symbol] |+2| [symbol] |=|P|≥d₁(E(x), [symbol] ′)≥r, a contradiction. If x∈ [symbol] ⁻, then to attain misclassification |P|≥d₁(E(x), [symbol] ′). However, this implies that r≥| [symbol] |+2| [symbol] |=|P|≥d₁(E(x), [symbol] ′)>r, another contradiction.

Conversely, assume that τ′ is r-robust. Since r≥0, it follows that τ′ is in particular (0, 0)-robust, and hence according to Eqn. (1) it follows that sign(xw^{T}−θ)=sign(E(x)v^{T}−μ) for every x∈ [symbol] ₂ⁿ. Assume for contradiction that r>d₁(E( [symbol] ⁺), [symbol] ′), which implies that there exists x∈ [symbol] ⁺ such that r>d₁(E(x), [symbol] ′), and let Bₓ [symbol] [symbol] ₁(E(x), r)∩[−1,1]^{m}. This result implies that some vertex y of [symbol] ₓ lies on the opposite side of [symbol] . It can be proven that y is an integer point, and that all such points correspond to erasures in some set [symbol] and errors in some set [symbol] such that | [symbol] |+2| [symbol] |≤r. Therefore, the existence of y contradicts the r-robustness of τ′. The proof that r<d₁(E( [symbol] ⁻), [symbol] ′) is similar.

In various aspects, redundancy is necessary to impart any nontrivial robustness to a neuron of a neural network. Since any non-constant neuron includes positive point x and a negative point y such that d_{H} (x, y)=1, and since any hyperplane must cross the convex hull of x and y, the following is immediate.

In various other aspects, unless τ(x)=sign(xw^{T}−θ) is constant, the solution (E, v, μ)=(Id, w, θ) is 0-robust.

Further, by denoting δ=d₁( [symbol] ₂ⁿ, [symbol] (w,θ)), the relative distance of the solution (Id, w, θ) is δ/n. However, computing δ for a given neuron δ is in general NP-complete, by a reduction to partition.

### F. Robustness by Replication

In various aspect, replication may be used to obtain robustness as described below. For a vector v, let v(t) be the result of concatenating v with itself [symbol] times, and for E: [symbol] ₂ⁿ→ [symbol] ₂^{m} let [symbol] : [symbol] ₂ⁿ→ [symbol] be the function [symbol] (x)=E [symbol] .

If (E, v, μ) is a solution with minimum distance d, for every positive integer [symbol] , the solution (E( [symbol] ), v( [symbol] ), [symbol] μ) has distance [symbol] d and identical relative distance d/m.

By way of proof, since ∥ [symbol] ∥_{∞}=∥v∥_{∞}, we have that

$${d}_{1} ( {E}_{( l )} ( {𝔽}_{2}^{n} ) , ℋ ( {v}_{( l )} , l μ ) ) = \frac{{min}_{x ∈ {𝔽}_{2}^{n}} \vert {E}_{( l )} ( x ) {v}_{( l )}^{T} - l μ \vert}{{‖ v ‖}_{∞}} ,$$

and since E₍ [symbol] ₎(x)v₍ [symbol] ₎^{T}= [symbol] ·E(x)v^{T}, it follows that this equals

$$ℓ \cdot \frac{{min}_{x ∈ {𝔽}_{2}^{n}} \vert E ( x ) {v}^{T} - μ \vert}{{‖ v ‖}_{∞}} = ℓ d ,$$

and thus the relative distance is [symbol] d/ [symbol] m=d/m.

Therefore, by applying the [symbol] -replication code E(x)=x₍ₜ₎, one can obtain robustness but not increase the relative distance. Moreover, since computing the aforementioned δ is NP-hard, explicit robustness guarantees are hard to come by.

G. Robustness from the Fourier Spectrum

In various aspect, a Fourier spectrum may be used to obtain robustness as described below. Every function ƒ: [symbol] r₂ⁿ→ [symbol] (and in particular, every neuron τ) can be written as a linear combination ƒ(x)= [symbol] \hat{ƒ}( [symbol] )χ [symbol] (x), where χ [symbol] (x) [symbol] [symbol] xₛ and \hat{ƒ}( [symbol] )= [symbol] ₓχ [symbol] (x)ƒ(x) for every [symbol] ⊆[n]. The vector \hat{ƒ}Ø(\hat{ƒ}( [symbol] ) is called the [n] Fourier spectrum of ƒ and if ƒ is Boolean then ∥\hat{ƒ}∥₂=1. We denote by \hat{ƒ}_{Ø} the vector \hat{ƒ} with its Ø-entry omitted, i.e., \hat{ƒ}_{Ø} [symbol] (\hat{ƒ}( [symbol] We refer to the following solution as the Fourier solution.

Lemma 4. For a neuron τ, the coded neuron τ′(E(x)) [symbol] sign [symbol] \hat{τ}( [symbol] )χ [symbol] (x)τ′(E(x)) has minimum distance ∥\hat{τ}_{Ø}∥_{∞}⁻¹.

By way of proof, notice that is defined by the encoding function E: [symbol] ₂ⁿ→ [symbol] ₂²^{ⁿ}⁻¹ such that E (x)=(χ [symbol] ( [symbol] known as the punctured Hadamard encoder. In addition, the respective halfspace is [symbol] = [symbol] (\hat{τ}_{Ø}−\hat{τ}(Ø)) [symbol] {y∈ [symbol] ₂²^{ⁿ}⁻¹ [symbol] y [symbol] \hat{τ}( [symbol] )+\hat{τ}(Ø)=0, where the coordinates of [symbol] ₂²^{ⁿ}⁻¹ are indexed by all nonempty subsets of [n]. To find the minimum distance of the Fourier solution, we compute:

$${d}_{1} ( E ( {𝔽}_{2}^{n} ) , ℋ ) = \frac{{min}_{x ∈ {𝔽}_{2}^{n}} \vert {\hat{τ}}_{∅} E ( x ) + \hat{τ} ( ∅ ) \vert}{{‖ {\hat{τ}}_{∅} ‖}_{∞}} = \frac{{min}_{x ∈ {𝔽}_{2}^{n}} \vert {Σ}_{S ⊆ [ n ]} \hat{τ} ( S ) X S ( x ) \vert}{{‖ {\hat{τ}}_{∅} ‖}_{∞}} = {‖ {\hat{τ}}_{∅} ‖}_{∞}^{- 1} ,$$

where the last equality follows since τ(x) [symbol] \hat{τ}( [symbol] )χ [symbol] (x)∈{±1}.

The relative distance of this solution is ∥\hat{τ}_{Ø}∥_{∞}⁻¹/(2ⁿ−1), and notice that unlike replication (Subsection III-A), it does not depend on the particular way in which is given. However, this solution involves exponentially many redundant bits, and in at least some networks may be impractical.

H. Robustness from the Parity Code

In various aspect, a parity code may be used to obtain robustness as described below. In some aspects, the parity code is used to obtain robustness in DNNs that employ binary neurons, i.e., neurons in which w∈ [symbol] ₂ⁿ. This family of DNNs includes, but is not limited to, binarized neural networks. In additional aspects, this approach may be applied to all neurons, and demonstrate its superiority over replication in cases where ∥w∥₁ is bounded. Specifically, we show that the parity code attains relative distance 2/(n+1), which outperforms replication.

Denoting [symbol] [symbol] {τ: [symbol] ₂ⁿ→ [symbol] ₂|τ(x)=sign(xw^{T}−θ) and w∈ [symbol] ₂ⁿ}, and since xw^{T}∈{−n, −n+2, . . . , n} or every x and w in [symbol] ₂ⁿ, it follows that for every τ∈ [symbol] one can round the respective θ to the nearest value in {−n−1, −n+1, . . . , n+1} without altering τ. Hence, we assume without loss of generality that all given θ's are in {−n−1, −n+1, . . . , n+1}. With this choice of θ, any function ƒ∈ [symbol] has δ=1, since

$$\begin{matrix}δ = {d}_{1} ( {𝔽}_{2}^{n} ℋ ( w , θ ) ) = \frac{{min}_{x ∈ {𝔽}_{2}^{n}} \vert {xw}^{T} - θ \vert}{{‖ w ‖}_{∞}} \\ = {min}_{x ∈ {𝔽}_{2}^{n}} \vert {xw}^{T} - θ \vert = 1\end{matrix}$$

In various aspects, replication achieves relative distance 1/n (e.g., 2-replication achieves 1-robustness with m=2n).

Additional notations may be employed from Boolean algebra. For x, w∈− [symbol] ⁿ let x⊕w denote their pointwise product, which amounts to Boolean sum if both x and w are in [symbol] ₂ⁿ. Further, for x∈ [symbol] ₂ⁿ we let WI/(x) be the number of (−1)-entries in x, known as Hamming weight. The next two lemmas demonstrate that functions in [symbol] depend only on w_{H}x⊕w).

Lemma 5. For every x and w in [symbol] ₂ⁿ we have xw^{T}=n−2w_{H}(x⊕w).

Lemma 6. For every τ∈ [symbol] and every x∈ [symbol] ₂ⁿ we have

$$τ ( x ) = \{ \begin{matrix}1 & {w}_{H} ( x ⊕ w ) \leq \frac{n - θ - 1}{2} \\ - 1 & {w}_{H} ( x ⊕ w ) \geq \frac{n - θ - 1}{2}\end{matrix}$$

Let m=n+1 and define E: [symbol] ₂ⁿ→ [symbol] ₂ⁿ⁺¹ as the parity encoder E(x)=(x1, . . . , xn, χ_{[n]}(x)). Then, we let

$${θ}^{′} {=}^{Δ} \frac{n - θ - 1}{2} ,$$

and define the parity solution (E, v, μ), where
v=w₁, . . . , wₙ, (−1)^{θ′}χ_{[n]}(w)), and
μ−θ.

Lemma 7. The relative distance of the parity solution is 2/(n+1).

By way of proof, d₁(E( [symbol] ₂ⁿ), [symbol] )=2, where [symbol] = [symbol] (v, θ).

Since ∥v∥_{∞}=1, Lemma 1 implies that

$${d}_{1} ( E ( {𝔽}_{2}^{n} ) , ℋ ) = {min}_{x ∈ {𝔽}_{2}^{n}} \vert E ( x ) \cdot {v}^{T} - θ \vert$$

and hence it suffices to show that |E(x)vT−θ|≥2 for every x∈F and that the coded neuron always correctly computes τ. Since χ[n](w)·χ[n](x)=χ[n](w⊕x)=(−1)wH(w⊕x), Lemma 5 implies that

$$\begin{matrix}E ( x ) {v}^{T} - θ = {xw}^{T} + {( - 1 )}^{{θ}^{′}} {χ}_{[ n ]} ( w ) \cdot {χ}_{[ n ]} ( x ) - θ \\ = n - 2 {w}_{H} ( x ⊕ w ) + {( - 1 )}^{{θ}^{′} + {w}_{H} ( x ⊕ w )} - θ ,\end{matrix} \qquad ( 1 )$$

and we distinguish between the next four cases:

$$Case 1 : If {w}_{H} ( x ⊕ w ) \leq \frac{n - θ - 1}{2} - 1 , \\ then ( 3 ) \geq n - ( n - θ - 1 ) + 2 + {( - 1 )}^{{θ}^{′} + {w}_{H} ( w ⊕ x )} - θ = 3 + {( - 1 )}^{{θ}^{′} + {w}_{H} ( w ⊕ x )} \geq 2.$$

$$Case 2 : If {w}_{H} ( x ⊕ w ) \leq \frac{n - θ - 1}{2} , \\ then ( 3 ) = n - ( n - θ - 1 ) + {( - 1 )}^{{θ}^{′} - \frac{n - θ - 1}{2}} - θ = 1 + {( - 1 )}^{θ} = 2.$$

$$Case 3 : If {w}_{H} ( x ⊕ w ) = \frac{n - θ + 1}{2} , \\ then ( 3 ) = n - ( n - θ + 1 ) + {( - 1 )}^{{θ}^{′} + \frac{n - θ + 1}{2}} - θ = - 1 + {( - 1 )}^{n - θ} = - 2 ,$$

where the last equality follows since n−θ is always odd.

$$Case 4 : If {w}_{H} ( x ⊕ w ) \geq \frac{n - θ + 1}{2} + 1 , \\ then ( 3 ) \leq n - ( n - θ + 1 ) - 2 + {( - 1 )}^{{θ}^{′} + {w}_{H} ( x ⊕ w )} - θ = - 3 + {( - 1 )}^{{θ}^{′} + {w}_{H} ( x ⊕ w )} \leq - 2.$$

Now, it follows from Lemma 6 and from the first two cases that sign(E(x)v^{T}−θ)=1 whenever τ(x)=1. Similarly, the latter two cases imply that sign(E(x)v^{T}−θ)=1 whenever τ(x)=1. Therefore, the coded neuron τ′(E(x))=sign(E(x)v^{T}−θ) correctly computes i on all inputs with minimum distance d=2, and the claim follows.

By using the parity solution, one can attain 1-robustness, i.e., robustness against any single (adversarial) erasure, by adding only one bit of redundancy. In contrast, to attain 1-robustness by using replication (Subsection III-A), one should add n bits of redundancy. Moreover, it is readily verified that due to Lemma 2, the suggested solution is optimal in terms of the length m=n+1 among all 1-robust solutions.

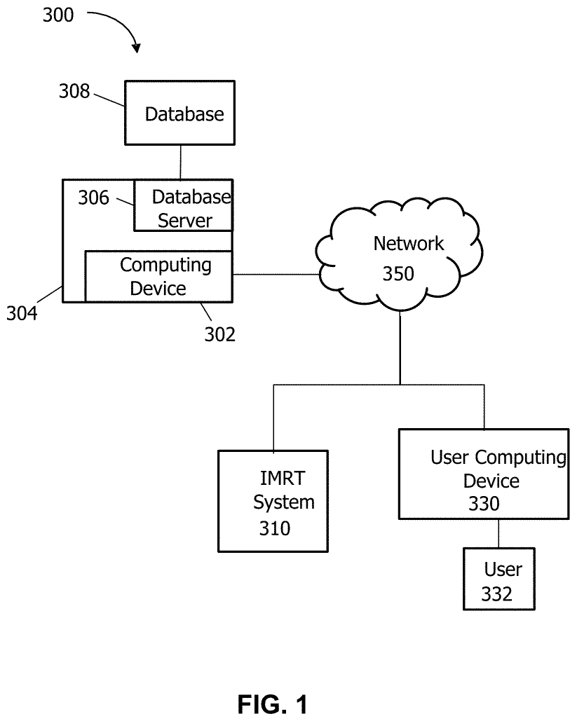

Since the parity function E is universal to all binary neurons, every DNN which comprises binary neurons (and in particular, binarized DNNs) can be made robust to adversarial tampering in its input. Furthermore, to employ this technique for error inside the DNN, one should add a single parity gate in every layer (see FIG. 1e).

### I. Generalized Parity for all Neurons

The following generalizes the parity code, and requires integer weights. Since every neurons has a representation with only integer weights it applies to all neurons. However, superiority to replication in terms of relative distance is guaranteed only if

$${‖ w ‖}_{1} < \frac{2 n}{δ} - 1.$$

Theorem 2. The relative distance of the solution (E_{w}, v, θ) is 2/(∥w∥₁+1), where

$$v = ( {1}_{w} , {( - 1 )}^{{θ}^{′}} χ [ {‖ w ‖}_{1} ] ( {1}_{w} ) ) , \\ {1}_{w} - {\underbrace{( sign ( {w}_{1} ) , … , sign ( {w}_{1} )}}_{\vert {w}_{1} \vert times} , … , {\underbrace{sign ( {w}_{n} ) , … , sign ( {w}_{n} ) )}}_{\vert {w}_{n} \vert times} and$$

$${E}_{w} ( x ) = ( {\underbrace{{x}_{1} , … , {x}_{1}}}_{\vert {w}_{1} \vert times} , … , {\underbrace{{x}_{n} , … , {x}_{n}}}_{\vert {w}_{n} \vert times} , {\prod }_{i = 1}^{n} {x}_{i}^{{w}_{1} mod 2} ) .$$

### J. Computing Systems and Devices

FIG. 1 depicts a simplified block diagram of a computing device 300 for implementing the methods described herein. As illustrated in FIG. 1, the computing device 300 may be configured to implement at least a portion of the tasks associated with disclosed method using the system 310. The computer system 300 may include a computing device 302. In one aspect, the computing device 302 is part of a server system 304, which also includes a database server 306. The computing device 302 is in communication with a database 308 through the database server 306. The computing device 302 is communicably coupled to the system 310 and a user computing device 330 through a network 350. The network 350 may be any network that allows local area or wide area communication between the devices. For example, the network 350 may allow communicative coupling to the Internet through at least one of many interfaces including, but not limited to, at least one of a network, such as the Internet, a local area network (LAN), a wide area network (WAN), an integrated services digital network (ISDN), a dial-up-connection, a digital subscriber line (DSL), a cellular phone connection, and a cable modem. The user computing device 330 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

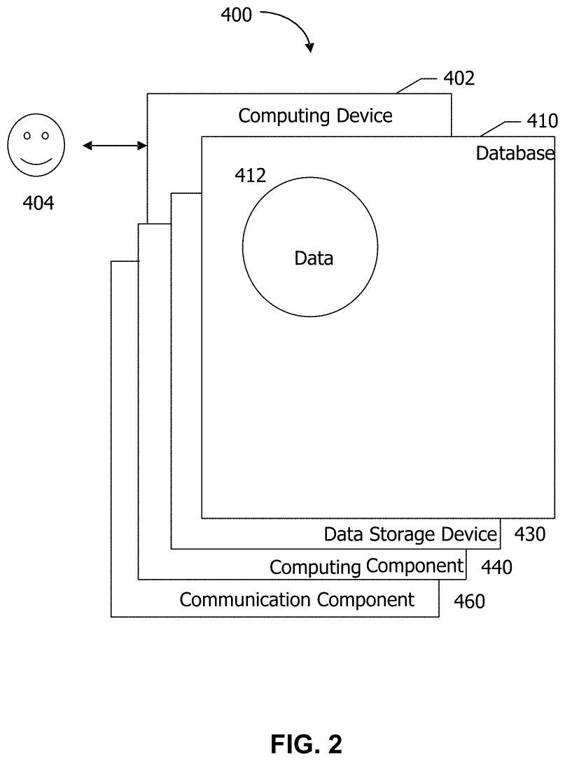

In other aspects, the computing device 302 is configured to perform a plurality of tasks associated with the disclosed method. FIG. 2 depicts a component configuration 400 of computing device 402, which includes database 410 along with other related computing components. In some aspects, computing device 402 is similar to computing device 302 (shown in FIG. 1). A user 404 may access components of computing device 402. In some aspects, database 410 is similar to database 308 (shown in FIG. 1).

In one aspect, database 410 includes various data 412. Non-limiting examples of suitable algorithm data 412 includes any values of parameters defining the disclosed method, such as any of the parameters from the equations described herein.

Computing device 402 also includes a number of components that perform specific tasks. In the example aspect, computing device 402 includes data storage device 430, computing component 440, and communication component 460. Data storage device 430 is configured to store data received or generated by computing device 402, such as any of the data stored in database 410 or any outputs of processes implemented by any component of computing device 402. Computing component 440 is configured to perform the tasks associated with the method described herein in various aspects.

Communication component 460 is configured to enable communications between computing device 402 and other devices (e.g. user computing device 330 and IMRT system 310, shown in FIG. 1) over a network, such as network 350 (shown in FIG. 1), or a plurality of network connections using predefined network protocols such as TCP/IP (Transmission Control Protocol/Internet Protocol).

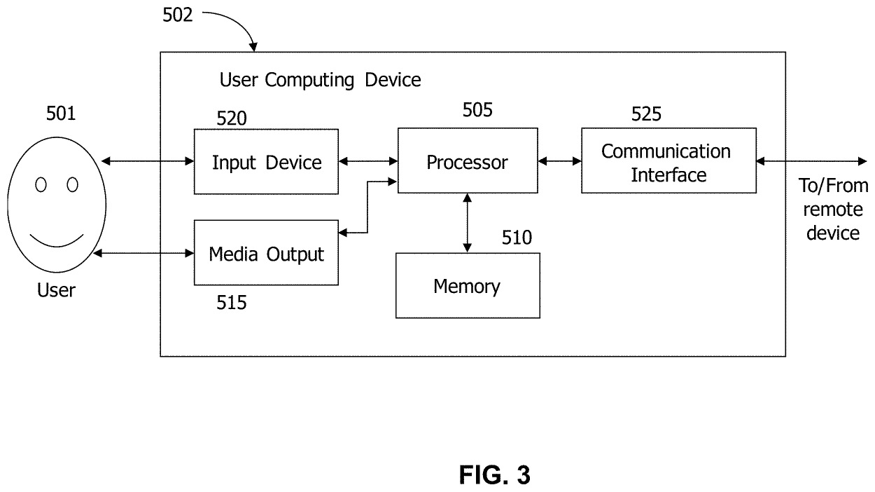

FIG. 3 depicts a configuration of a remote or user computing device 502, such as user computing device 330 (shown in FIG. 1). Computing device 502 may include a processor 505 for executing instructions. In some aspects, executable instructions may be stored in a memory area 510. Processor 505 may include one or more processing units (e.g., in a multi-core configuration). Memory area 510 may be any device allowing information such as executable instructions and/or other data to be stored and retrieved. Memory area 510 may include one or more computer-readable media.

Computing device 502 may also include at least one media output component 515 for presenting information to a user 501. Media output component 515 may be any component capable of conveying information to user 501. In some aspects, media output component 515 may include an output adapter, such as a video adapter and/or an audio adapter. An output adapter may be operatively coupled to processor 505 and operatively coupleable to an output device such as a display device (e.g., a liquid crystal display (LCD), organic light emitting diode (OLED) display, cathode ray tube (CRT), or “electronic ink” display) or an audio output device (e.g., a speaker or headphones). In some aspects, media output component 515 may be configured to present an interactive user interface (e.g., a web browser or client application) to user 501.

In some aspects, computing device 502 may include an input device 520 for receiving input from user 501. Input device 520 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 515 and input device 520.

Computing device 502 may also include a communication interface 525, which may be communicatively coupleable to a remote device. Communication interface 525 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 510 are, for example, computer-readable instructions for providing a user interface to user 501 via media output component 515 and, optionally, receiving and processing input from input device 520. A user interface may include, among other possibilities, a web browser and client application. Web browsers enable users 501 to display and interact with media and other information typically embedded on a web page or a website from a web server. A client application allows users 501 to interact with a server application associated with, for example, a vendor or business.

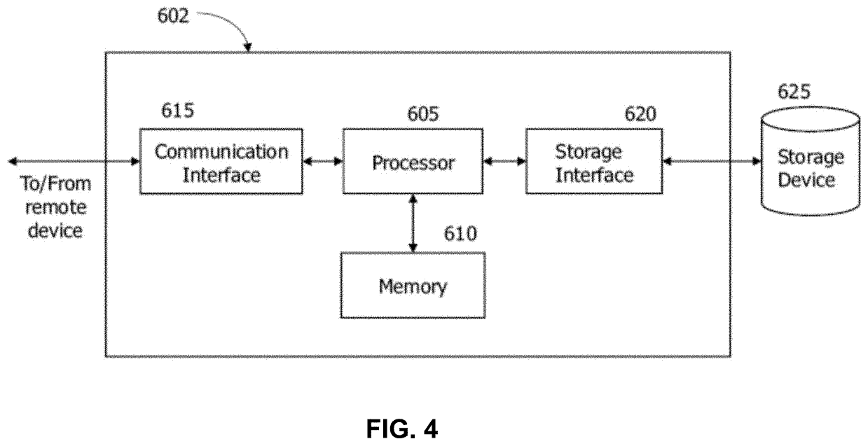

FIG. 4 illustrates an example configuration of a server system 602. Server system 602 may include, but is not limited to, database server 306 and computing device 302 (both shown in FIG. 1). In some aspects, server system 602 is similar to server system 304 (shown in FIG. 1). Server system 602 may include a processor 605 for executing instructions. Instructions may be stored in a memory area 625, for example. Processor 605 may include one or more processing units (e.g., in a multi-core configuration).

Processor 605 may be operatively coupled to a communication interface 615 such that server system 602 may be capable of communicating with a remote device such as user computing device 330 (shown in FIG. 1) or another server system 602. For example, communication interface 615 may receive requests from user computing device 330 via a network 350 (shown in FIG. 1).

Processor 605 may also be operatively coupled to a storage device 625. Storage device 625 may be any computer-operated hardware suitable for storing and/or retrieving data. In some aspects, storage device 625 may be integrated in server system 602. For example, server system 602 may include one or more hard disk drives as storage device 625. In other aspects, storage device 625 may be external to server system 602 and may be accessed by a plurality of server systems 602. For example, storage device 625 may include multiple storage units such as hard disks or solid state disks in a redundant array of inexpensive disks (RAID) configuration. Storage device 625 may include a storage area network (SAN) and/or a network attached storage (NAS) system.

In some aspects, processor 605 may be operatively coupled to storage device 625 via a storage interface 620. Storage interface 620 may be any component capable of providing processor 605 with access to storage device 625. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 625.

Memory areas 510 (shown in FIG. 3) and 610 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

The computer systems and computer-implemented methods discussed herein may include additional, less, or alternate actions and/or functionalities, including those discussed elsewhere herein. The computer systems may include or be implemented via computer-executable instructions stored on non-transitory computer-readable media. The methods may be implemented via one or more local or remote processors, transceivers, servers, and/or sensors (such as processors, transceivers, servers, and/or sensors mounted on vehicle or mobile devices, or associated with smart infrastructure or remote servers), and/or via computer executable instructions stored on non-transitory computer-readable media or medium.

In some aspects, a computing device is configured to implement machine learning, such that the computing device “learns” to analyze, organize, and/or process data without being explicitly programmed. Machine learning may be implemented through machine learning (ML) methods and algorithms. In one aspect, a machine learning (ML) module is configured to implement ML methods and algorithms. In some aspects, ML methods and algorithms are applied to data inputs and generate machine learning (ML) outputs. Data inputs may include but are not limited to: images or frames of a video, object characteristics, and object categorizations. Data inputs may further include: sensor data, image data, video data, telematics data, authentication data, authorization data, security data, mobile device data, geolocation information, transaction data, personal identification data, financial data, usage data, weather pattern data, “big data” sets, and/or user preference data. ML outputs may include but are not limited to: a tracked shape output, categorization of an object, categorization of a type of motion, a diagnosis based on motion of an object, motion analysis of an object, and trained model parameters ML outputs may further include: speech recognition, image or video recognition, medical diagnoses, statistical or financial models, autonomous vehicle decision-making models, robotics behavior modeling, fraud detection analysis, user recommendations and personalization, game AI, skill acquisition, targeted marketing, big data visualization, weather forecasting, and/or information extracted about a computer device, a user, a home, a vehicle, or a party of a transaction. In some aspects, data inputs may include certain ML outputs.

In some aspects, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, dimensionality reduction, and support vector machines. In various aspects, the implemented ML methods and algorithms are directed toward at least one of a plurality of categorizations of machine learning, such as supervised learning, unsupervised learning, and reinforcement learning.

In one aspect, ML methods and algorithms are directed toward supervised learning, which involves identifying patterns in existing data to make predictions about subsequently received data. Specifically, ML methods and algorithms directed toward supervised learning are “trained” through training data, which includes example inputs and associated example outputs. Based on the training data, the ML methods and algorithms may generate a predictive function that maps outputs to inputs and utilize the predictive function to generate ML outputs based on data inputs. The example inputs and example outputs of the training data may include any of the data inputs or ML outputs described above.

In another aspect, ML methods and algorithms are directed toward unsupervised learning, which involves finding meaningful relationships in unorganized data. Unlike supervised learning, unsupervised learning does not involve user-initiated training based on example inputs with associated outputs. Rather, in unsupervised learning, unlabeled data, which may be any combination of data inputs and/or ML outputs as described above, is organized according to an algorithm-determined relationship.

In yet another aspect, ML methods and algorithms are directed toward reinforcement learning, which involves optimizing outputs based on feedback from a reward signal. Specifically ML methods and algorithms directed toward reinforcement learning may receive a user-defined reward signal definition, receive a data input, utilize a decision-making model to generate a ML output based on the data input, receive a reward signal based on the reward signal definition and the ML output, and alter the decision-making model so as to receive a stronger reward signal for subsequently generated ML outputs. The reward signal definition may be based on any of the data inputs or ML outputs described above. In one aspect, a ML module implements reinforcement learning in a user recommendation application. The ML module may utilize a decision-making model to generate a ranked list of options based on user information received from the user and may further receive selection data based on a user selection of one of the ranked options. A reward signal may be generated based on comparing the selection data to the ranking of the selected option. The ML module may update the decision-making model such that subsequently generated rankings more accurately predict a user selection.

As will be appreciated based upon the foregoing specification, the above-described aspects of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed aspects of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one aspect, a computer program is provided, and the program is embodied on a computer readable medium. In one aspect, the system is executed on a single computer system, without requiring a connection to a sever computer. In a further aspect, the system is being run in a Windows® environment (Windows is a registered trademark of Microsoft Corporation, Redmond, Wash.). In yet another aspect, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some aspects, the system includes multiple components distributed among a plurality of computing devices. One or more components may be in the form of computer-executable instructions embodied in a computer-readable medium. The systems and processes are not limited to the specific aspects described herein. In addition, components of each system and each process can be practiced independent and separate from other components and processes described herein. Each component and process can also be used in combination with other assembly packages and processes. The present aspects may enhance the functionality and functioning of computers and/or computer systems.

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein. The recitation of discrete values is understood to include ranges between each value.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

Any publications, patents, patent applications, and other references cited in this application are incorporated herein by reference in their entirety for all purposes to the same extent as if each individual publication, patent, patent application or other reference was specifically and individually indicated to be incorporated by reference in its entirety for all purposes. Citation of a reference herein shall not be construed as an admission that such is prior art to the present disclosure.

Having described the present disclosure in detail, it will be apparent that modifications, variations, and equivalent embodiments are possible without departing the scope of the present disclosure defined in the appended claims. Furthermore, it should be appreciated that all examples in the present disclosure are provided as non-limiting examples.

1. A computer-aided method for performing computations using adversarially-robust neural networks, the method comprising:
a. providing a uncoded neural network comprising a plurality of neurons and associated inputs for each of the plurality of neurons, each neuron configured to perform a calculation according to an activation function;
b. transforming, using the computing device, at least one uncoded neuron into a coded neuron by:
i. adding, using the computing device, an error correcting code as an additional input to the at least one uncoded neuron, the error correcting code comprising a redundant combination of the associated inputs off the uncoded neuron, and
ii. revising, using the computing device, the activation function of the at least one uncoded neuron to accommodate the error correcting code as the additional input.
